(19) United States
(12) Patent Application Publication
(10) Pub. No.: US 2025/0317832 A1
(43) Pub. Date: Oct. 9, 2025

(54) METHOD AND APPARATUS FOR SESSION CONTROL IN MULTI-ACCESS ENVIRONMENT OF WIRELESS COMMUNICATION SYSTEM

(71) Applicant: Samsung Electronics Co., Ltd., Gyeonggi-do (KR)

(72) Inventors: Dongeun SUH, Gyeonggi-do (KR); Sangjun MOON, Gyeonggi-do (KR); Hoyeon LEE, Gyeonggi-do (KR)

(21) Appl. No.: 19/172,132

(22) Filed: Apr. 7, 2025

(30) Foreign Application Priority Data
Apr. 5, 2024 (KR) 10-2024-0046962

(51) Int. Cl. H04W 48/08; H04W 48/18; H04W 60/04; H04W 76/10

(52) U.S. Cl. CPC H04W 48/08; H04W 48/18; H04W 60/04; H04W 76/10

(57) ABSTRACT

Disclosed is an operating method of an access and mobility function (AMF) in a wireless communication system, including receiving, from a user equipment (UE) supporting a dual steer (DS) function, a PDU session establishment request message through a registered 3GPP access network by using a second SUPI, determining whether a PDU session having a same S-NSSAI and DNN as an S-NSSAI and DNN included in the PDU session establishment request message is present for another 3GPP access based on subscriber information of the UE, and in case that the PDU session having the same S-NSSAI and DNN as the S-NSSAI and DNN included in the PDU session establishment request message is present for another 3GPP access, transmitting, to the UE, a PDU session reject message.

### CROSS-REFERENCE TO RELATED APPLICATION(S)

This application is based on and claims priority under 35 U.S.C. § 119 to Korean Patent Application No. 10-2024-0046962, filed on Apr. 5, 2024, in the Korean Intellectual Property Office, the entire disclosure of which is incorporated herein by reference.

### BACKGROUND

### 1. Field

The disclosure relates generally to a wireless communication system, and more particularly, to a method for session control in a multi-access environment of a wireless communication system.

### 2. Description of Related Art

To meet the increasing demand for wireless data traffic after the commercialization of 4th generation (4G) communication systems, efforts have been made to develop 5th generation (5G) or pre-5G communication systems which are referred to as beyond 4G network communication systems or post long term evolution (post-LTE) systems. To achieve high data rates, implementation of 5G communication systems in an ultra-high frequency or millimeter wave (mmWave) band (e.g., a 60 gigahertz (GHz) band) has been considered. To mitigate the path loss of radio waves and increase the transmission range of radio waves in the ultra-high frequency band, beamforming, massive multiple input multiple output (MIMO), full-dimensional MIMO (FD-MIMO), array antenna, analog beamforming, and large-scale antenna technologies have been discussed in the 5G communication systems. To improve system networks for 5G communication systems, various technologies such as evolved small cells, advanced small cells, cloud radio access networks (RAN), ultra-dense networks, device-to-device (D2D) communication, wireless backhaul, moving networks, cooperative communication, coordinated multi-points (COMP), and received-interference cancellation have been developed. In addition, advanced coding modulation (ACM) methods such as hybrid frequency shift keying (FSK) and quadrature amplitude modulation (QAM) (FQAM) and sliding window superposition coding (SWSC) and advanced access technologies such as filter bank multi carrier (FBMC), non-orthogonal multiple access (NOMA), and sparse code multiple access (SCMA) have been developed in the 5G systems.

Moreover, the Internet has evolved from a human-based connection network, where humans create and consume information, to the Internet of things (IoT), where distributed elements such as objects exchange information with each other to process the information. Internet of everything (IoE) technology as a combination of IoT technology and big data processing technology or the like through connection to cloud servers or the like has also emerged. Because technological elements such as sensing technology, wireless communication and network infrastructure, service interface technology, and security technology are required to implement the IoT, technologies such as sensor networks for connection between objects, machine-to-machine (M2M) communication, and machine-type communication (MTC) have been recently researched. In the IoT environment, intelligent information technology (IT) services may be provided to collect and analyze data generated from connected objects, to create new value in human life. As the existing IT and various industries converge and combine with each other, the IoT may be applied to various fields such as smart homes, smart buildings, smart cities, smart cars or connected cars, smart grids, health care, smart home appliances, and advanced medical services.

Accordingly, various attempts have been made to apply the 5G communication systems to the IoT networks. For example, technologies such as sensor networks, M2M communication, and MTC have been implemented by using various schemes such as beamforming, MIMO, and array antennas that are 5G communication technologies. Application of a cloud RAN as the big data processing technology described above may be an example of the convergence of the 5G technology and the IoT technology.

Efforts have also been made to develop 6th generation (6G) communication systems that are about five times faster than the maximum speed of the 5G communication systems. Accordingly, implementation in higher frequency bands than the 5G communication systems have been considered to achieve high data transmission rates.

The wireless communication system has evolved from providing an initial voice-oriented service into a broadband wireless communication system that provides a high-speed, high-quality packet data service, including communication standards such as third generation partnership project (3GPP) high speed packet access (HSPA), LTE or evolved universal terrestrial radio access (E-UTRA), LTE-advanced (LTE-A), LTE-Pro, 3GPP2 high rate packet data (HRPD), ultra mobile broadband (UMB), and institute of electrical and electronics engineers (IEEE) 802.16e.

As an example of the broadband wireless communication system, an LTE system may employ orthogonal frequency division multiplexing (OFDM) for a downlink (DL) and employ single carrier-frequency division multiple access (SC-FDMA) for an uplink (UL). The UL may refer to a wireless link in which a terminal (UE or MS) transmits data or control signals to a base station (eNode B or BS), and the DL may refer to a wireless link in which a base station transmits data or control signals to a terminal. The multiple access scheme described above may identify data or control information of each user by allocating time-frequency resources for carrying data or control information to respective users not to overlap each other and to achieve orthogonality therebetween.

Because the 5G communication system as a future communication system after LTE should be able to freely reflect various requirements of users and service providers, the 5G communication system should support services simultaneously satisfying various requirements, such as enhanced mobile broadband (eMBB), massive MTC (mMTC), and ultra-reliability low-latency communication (URLLC).

As various services may be provided due to the development of wireless communication systems described above, there is a need in the art for schemes for controlling sessions in multi-access environments.

### SUMMARY

The disclosure has been made to address at least the above-mentioned problems and/or disadvantages and to provide at least the advantages described below.

Accordingly, an aspect of the disclosure is to provide a method and apparatus for session control in a multi-access environment of a wireless communication system or a mobile communication system.

In accordance with an aspect of the disclosure, a method of an access and mobility function (AMF) in a wireless communication system may include receiving a registration request message including a dual steer (DS) function support indicator from a user equipment (UE) through a RAN, determining whether to allow registration of the UE based on subscription information of the UE, transmitting a registration acceptance message to the UE through the RAN, selecting a policy control function (PCF) and transmitting a request message for UE policy establishment to the PCF, receiving a response message to a UE policy establishment request from the PCF, receiving a request message for UE policy update from the PCF, and transmitting a message including new configuration information to the UE.

In accordance with an aspect of the disclosure, a method of an access and mobility function (AMF) in a wireless communication system may include receiving, from a user equipment (UE) supporting a dual steer (DS) function, a PDU session establishment request message through a registered 3GPP access network by using a second SUPI, determining whether a PDU session having a same S-NSSAI and DNN as an S-NSSAI and DNN included in the PDU session establishment request message is present for another 3GPP access based on subscriber information of the UE, and in case that the PDU session having the same S-NSSAI and DNN as the S-NSSAI and DNN included in the PDU session establishment request message is present for another 3GPP access, transmitting, to the UE, a PDU session reject message.

In accordance with an aspect of the disclosure, a method of a user equipment (UE) supporting a dual steer (DS) function in a wireless communication system may include transmitting, to an access and mobility function (AMF), a PDU session establishment request message through a registered 3GPP access network by using a second SUPI, and receiving, from a session management function (SMF), a PDU session establishment response message, wherein in case that the PDU session having a same S-NSSAI and DNN as an S-NSSAI and DNN included in the PDU session establishment request message is present for another 3GPP access, the PDU session establishment response message includes a PDU session reject message.

In accordance with an aspect of the disclosure, an AMF in a wireless communication system may include transceiver and at least one processor, configured to, receive, from a user equipment (UE) supporting a dual steer (DS) function, a PDU session establishment request message through a registered 3GPP access network by using a second SUPI, determine whether a PDU session having a same S-NSSAI and DNN as an S-NSSAI and DNN included in the PDU session establishment request message is present for another 3GPP access based on subscriber information of the UE, and in case that the PDU session having the same S-NSSAI and DNN as the S-NSSAI and DNN included in the PDU session establishment request message is present for another 3GPP access, transmit, to the UE, a PDU session reject message.

In accordance with an aspect of the disclosure, a UE supporting a DS function in a wireless communication system may include transceiver and at least one processor, configured to, transmit, to an access and mobility function (AMF), a PDU session establishment request message through a registered 3GPP access network by using a second SUPI, and receive, from a session management function (SMF), a PDU session establishment response message, wherein in case that the PDU session having a same S-NSSAI and DNN as an S-NSSAI and DNN included in the PDU session establishment request message is present for another 3GPP access, the PDU session establishment response message includes a PDU session reject message.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a 5G system according to an embodiment;

FIG. 2 illustrates a method of transmitting a dual steer (DS) policy and a UE routing selection policy (URSP) rule to a UE according to an embodiment;

FIG. 3 illustrates a method for session control in a multi-access environment of a wireless communication system according to an embodiment;

FIG. 4 illustrates a method for session control in a multi-access environment of a wireless communication system according to an embodiment; and

FIG. 5 illustrates a network entity according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Terms and names defined in the 3rd generation partnership project NR (3GPP NR) standards may be used for convenience of description. However, the disclosure is not limited to the above terms and names and may also be similarly applied to systems according to other standards. Herein, a terminal may refer to other wireless communication devices in addition to mobile phones, such as narrowband Internet of things (NB-IoT) devices, and sensors.

Hereinafter, the base station may be an agent performing terminal resource allocation and may be at least one of a gNode B (gNB), an eNode B (eNB), a Node B (NB), a BS, a radio access unit, a base station controller, or a node on a network. The terminal may include a UE, a mobile station (MS), a cellular phone, a smartphone, a computer, or a multimedia system that may perform a communication function. However, the disclosure is not limited thereto.

The disclosure may be applied to 3GPP NR (5G mobile communication standard). The disclosure may be applied to intelligent services (e.g., smart home, smart building, smart city, smart car or connected car, health care, digital education, retailing, security, and safety services) based on 5G communication technology and IoT technology.

Although embodiments of the disclosure will be described below by using LTE, LTE-A, LTE Pro, or a 5G NR system as an example, the disclosure may also be applied to other communication systems having similar technical backgrounds or channel types and to other communication systems through some modifications at the discretion of those of ordinary skill in the art without materially departing from the scope of the disclosure.

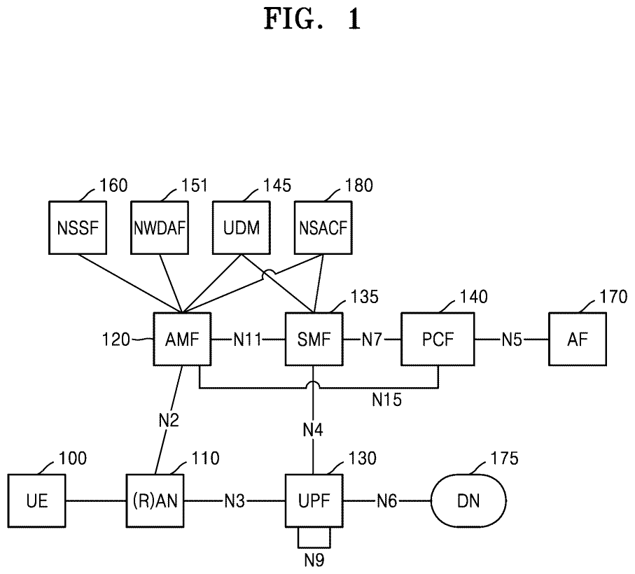

FIG. 1 illustrates a 5G system according to an embodiment.

Referring to FIG. 1, a 5G mobile communication network may include a 5G UE (or a terminal) 100, a 5G RAN (or a base station, a gNB (5G NodeB), an eNB (evolved NodeB), or the like) 110, and a 5G core network. The 5G core network may include network functions (NFs) such as an access and mobility management function (AMF) 120 providing UE mobility management, a session management function (SMF) 135 providing session management, a user plane function (UPF) 130 performing data transmission, a policy control function (PCF) 140 providing policy control, a unified data management (UDM) 145 providing data management such as subscriber data and policy control data, and a unified data repository (UDR) storing data of various NFs such as UDM 145. The 5G core network may further include NFs such as a network slice selection function (NSSF) 160, a network data analytic function (NWDAF) 151, an application function (AF) 170, a data network (DN) 175, and a network slice admission control function (NSACF) 180.

In the 3GPP system, a conceptual link connecting NFs to each other in the 5G system may be defined as a reference point. For example, referring to FIG. 1, the reference points included in the 5G system architecture may be as follows.
N1 is a reference point between UE 100 and AMF 120
N2 is a reference point between (R)AN 110 and AMF 120
N3 is a reference point between (R)AN 110 and UPF 130
N4 is a reference point between SMF 135 and UPF 130
N5 is a reference point between PCF 140 and AF 170
N6 is a reference point between UPF 130 and DN 175
N7 is a reference point between SMF 135 and PCF 140
N8 is a reference point between UDM 145 and AMF 120
N9 is a reference point between two core UPFs 130
N10 is a reference point between UDM 145 and SMF 135
N11 is a reference point between AMF 120 and SMF 135
N12 is a reference point between AMF 120 and authentication server function (AUSF)
N13 is a reference point between UDM 145 and AUSF
N14 is a reference point between two AMFs 120
N15 is a reference point between PCF 140 and AMF 120 in a non-roaming scenario or reference point between PCF 140 and AMF 120 in visited network in a roaming scenario.

In the 5G system, network slicing may refer to a technology and structure that enable multiple virtualized independent logical networks in a single physical network. To satisfy the specialized requirements of a service/application, a network operator may configure a virtual end-to-end network referred to as a network slice to provide a service. In this case, the network slice may be distinguished by an identifier (ID) referred to as single-network slice selection assistance information (S-NSSAI). The network may transmit a set of allowed slices (e.g., allowed NSSAI(s)) to the terminal in a terminal registration procedure (e.g., UE registration procedure), and the terminal may transmit/receive application data through a protocol data unit (PDU) session generated through one of the S-NSSAIs (i.e., a network slice). Hereinafter, an operation of an NF may be understood as an operation of an orchestration and management (OAM).

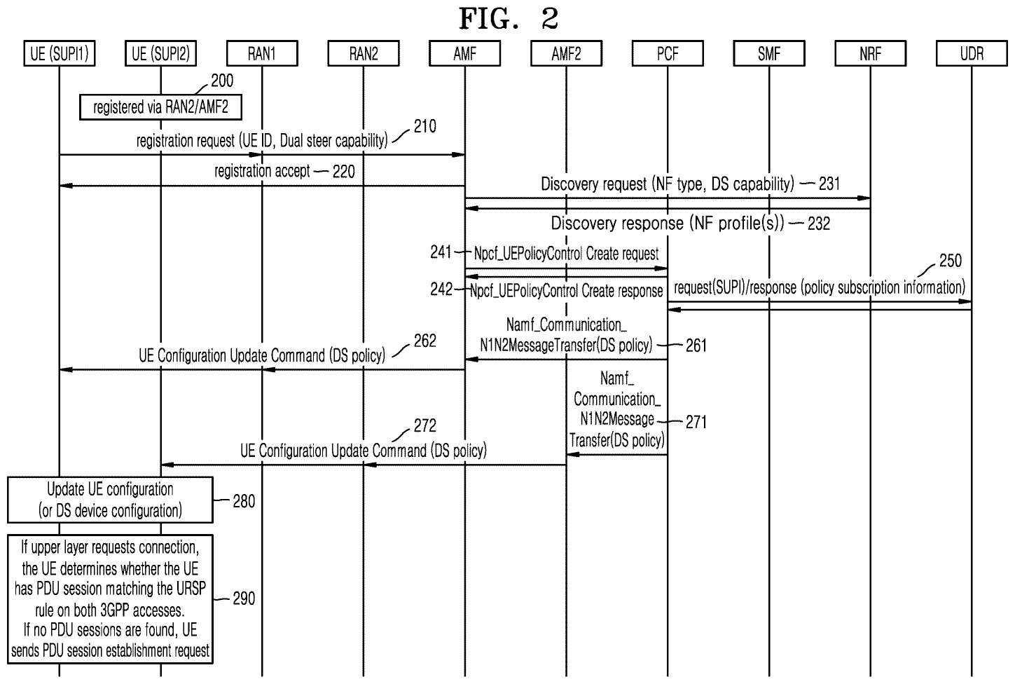

FIG. 2 illustrates a method of transmitting a DS policy and a URSP rule to a UE according to an embodiment.

Referring to FIG. 2, in step 200, the UE may perform a registration in a second AMF (AMF2) through a second RAN (RAN2) by using a second subscription permanent ID (SUPI) (SUPI2).

In step 210, the UE may transmit a registration request message to an AMF through a first RAN (RAN1). The registration request message may include a DS function support indicator (DS capability) (e.g., an indicator indicating that registration of two 3GPP accesses is supported, an indicator indicating that use of two 3GPP accesses is supported, or the like) or an indicator indicating that a DS function is usable. The UE may include a UE ID based on a first SUPI (SUPI1) in a request message.

In step 220, when the AMF receives the registration request message from the UE, the AMF may determine whether to allow UE registration based on subscription information of the UE. The AMF may transmit a registration response message (e.g., registration accept message) to the UE through the RAN1.

The AMF may perform a PCF selection. Specifically, in step 231, when the message in step 210 includes DS capability, the AMF may transmit, to a network repository function (NRF), a discovery request message including at least one of the following pieces of information.
NF capability: the AMF may include the capability of an NF to be found in NF Capability. When the message in step 210 includes DS capability, the AMF may include DS capability in the request message (discovery request).
Target NF type: NF type indicating PCF
AMF instance ID: Own NF instance ID

When the NRF receives the request message in step 231 from the AMF, the NRF may include, in the response message, information about NF instances that satisfy the conditions included in the message (e.g., an NF profile that may include an NF instance ID and an NF instance address (a fully qualified domain name (FQDN)). When the NF type is PCF in the message received from the AMF and the NF capability includes DS capability, the NRF may include, in the response message, one or more of the PCF instances supporting DS capability (e.g., NFs having an NF profile including DS capability). In step 232, the NRF may transmit a discovery response message to the AMF.

The AMF may select one of the NF profiles (e.g., NF instances) included in the response message received from the NRF in step 232.

In step 241, the AMF may transmit a create request message for UE policy association establishment to the selected PCF. When the registration request message received from the UE in step 210 includes a DS function support indicator, the AMF may include the DS function support indicator in the create request message transmitted to the PCF in step 241. The create request message in step 241 may include a UE ID (e.g., SUPI1).

In step 242, the PCF may transmit, to the AMF, a create response message including the result (success or failure) of the UE policy association establishment request message received from the AMF.

In step 250, when the PCF accepts the UE policy association establishment in steps 241 and 242, the PCF may transmit the UE policy to the UE through a UE configuration update procedure. The PCF may transmit a message for requesting policy control subscription information about the UE (e.g., a request) to a UDR to generate the UE policy. The UDR may transmit a response message including the policy control subscription information to the PCF. The policy control subscription information may include whether to allow a DS function for the UE, which may be provided for each S-NSSAI, data network name (DNN), or public land mobile network (PLMN) ID. When the message received from the AMF includes an indicator indicating that the UE supports DS capability or when the message received from the UDR includes an indicator indicating that the UE allows DS capability, the PCF may determine to transmit the DS policy and the URSP rule reflecting the DS and for selecting two 3GPP accesses.

When the UE is a UE supporting or allowing the DS and when the UE is registered in two 3GPP accesses and served through different AMFs, the PCF may determine through which of the two 3GPP accesses is to be transmitted (e.g., when transmitted in steps 261 and 262 or in steps 271 and 272). For example, the PCF may preferentially select the 3GPP access in which connection of the UE to the network is activated. When connection to the network is activated for both 3GPP accesses (e.g., in the case of CM_CONNECTED), the PCF may preferentially select the 3GPP access connected to the terrestrial radio access technology (RAT) by considering the RAT type (i.e., select the 3GPP access connected to the non-terrestrial RAT (e.g., NR (LEO), NR (MEO), or NR (GEO)) with the lowest priority).

In step 261, the PCF may transmit a request message for UE policy update to the AMF managing the selected 3GPP access.

When the UE supports the DS function, the PCF may include the following information in the message transmitted to the AMF in a transparent container (e.g., a UE policy container) transmitted to the UE.

DS policy: The message may include whether two 3GPP accesses may be simultaneously used. The information may be provided for each PLMN. Additionally, whether the same service (e.g., S-NSSAI or DNN) is allowed to be transmitted through two 3GPP accesses may be included therein. Even when the DS function is allowed to the UE, the PCF may not allow the DS function depending on the serving network situation or policy. When the PCF needs to control the energy usage of the UE, when the remaining battery capacity of the UE is restricted, the PCF may include, in the DS policy, information that disallows the use of two 3GPP accesses for the UE or may not include, in the message, information that allows the use of two 3GPP accesses. Even when the DS function (e.g., a function of simultaneous using two 3GPP accesses) is allowed for the UE and the S-NSSAI/DNN, the PCF may not allow the DS function depending on the serving network situation or policy (e.g., when the S-NSSAI/DNN is congested or when the energy usage of the S-NSSAI/DNN is too high).

UE route selection policy (URSP) rule: The message may include information about the path for which PLMN and/or RAT type should be preferentially selected for certain traffic. In this case, the URSP rule may include a traffic descriptor (information indicating application traffic, which may include connection capability, server IP address/port number/protocol, and/or server FQDN) and a route selection descriptor (information indicating a path for transmitting application traffic, which may include access preference, RAT preference, PLMN preference, S-NSSAI, and/or DNN). The access preference may include one or both of 3GPP access and non-3GPP access. The RAT preference may include RAT (e.g., may be classified into 5G NR, 5G NR (LEO), and the like or classified into terrestrial network RAT and non-terrestrial network RAT). When a plurality of RATs is included, the earliest RAT may be preferentially selected. The PLMN preference may include a PLMN ID. When a plurality of PLMN IDs is included, the earliest PLMN may be preferentially selected.

In step 262, the AMF may receive the message in step 261, and when a transparent container to be transmitted to the UE is in the message, may transmit the information to the UE through the RAN1. When the message received from the AMF through the RAN1 includes new configuration information, the UE may update the configuration information.

When the AMF receives the message in step 261 but the UE is unreachable, the AMF may transmit, to the PCF, a response message to step 261 including information indicating a failure. In this case, the PCF may perform UE policy transmission to the UE through another 3GPP access in steps 271 and 272.

In step 280, when a UE configuration update command received from the AMF includes the DS policy or the URSP rule(s), the UE may store the information. When there is prestored information, the prestored information may be deleted and the received information may be stored.

In step 290, when a connection request is generated from an upper layer, the UE may act as follows.

When the DS policy allows the same service to be used in two 3GPP accesses, when the upper layer requests a connection, the UE may determine whether the UE has a PDU session matching the URSP rule in one 3GPP access that has received the connection request. When there is no PDU session matching the URSP rule, the UE may transmit a PDU session establishment request to the AMF.

When the DS policy allows the same service to be used in two 3GPP accesses, when the upper layer requests a connection, the UE may transmit, to the AMF, an establishment request of a multi-access (MA) PDU session using two 3GPP accesses for the same S-NSSAI or DNN (e.g., a PDU session with two 3GPP access user planes).

When the DS policy disallows the same service to be used in two 3GPP accesses, when the upper layer requests a connection, the UE may determine whether the UE has a PDU session matching the URSP rule in both of the two registered 3GPP accesses of the UE. When there is no PDU session matching the URSP rule, the UE may transmit a PDU session establishment request to the AMF. When a matching PDU session is found among the two registered 3GPP accesses of the UE, the application traffic for the upper layer request received through the PDU session may be transmitted.

When the DS policy disallows the same service to be used in two 3GPP accesses, when the upper layer requests a connection, the UE may transmit an establishment request of an MA PDU session only through one 3GPP access for the same S-NSSAI or DNN (e.g., a PDU session with one 3GPP access user plane).

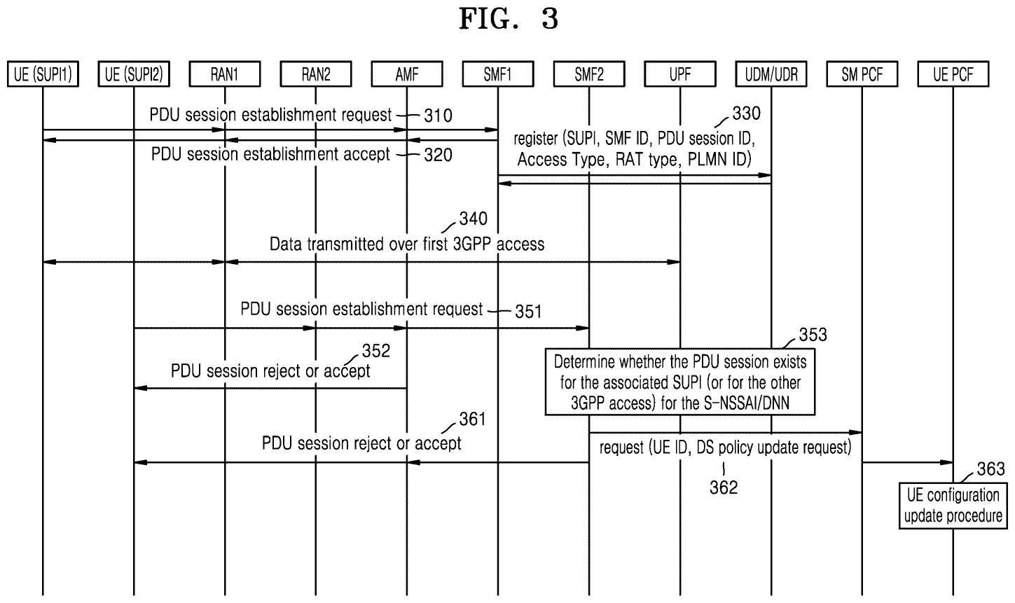

FIG. 3 illustrates a method for session control in a multi-access environment of a wireless communication system according to an embodiment.

Referring to FIG. 3, in step 310, the UE may transmit a PDU session establishment request message through a registered 3GPP access network by using a first SUPI (SUPI1). The UE may transmit a non-access stratum (NAS) message including the PDU session establishment request message to an AMF through a first RAN (RAN1). The message may include PDU session ID, S-NSSAI, DNN, and N1 session management (SM) container (PDU session establishment request).

When the AMF receives the PDU session establishment request message from the UE, the AMF may transmit an SM context create request message to an SMF (e.g., a first SMF (SMF1)). The SM context create request message may include PDU session ID, S-NSSAI, DNN, and N1 SM container (PDU session establishment request).

When the SMF receives the above message from the AMF, the SMF may perform a PDU session establishment procedure.

In step 320, the SMF may transmit a NAS message including the PDU session establishment accept to the UE through the AMF and the RAN1.

In step 330, the SMF1 may transmit, to a UDM, a message indicating that the SMF1 itself is a serving SMF for the PDU session. The message may include the following information.

SUPI (e.g., SUPI1), SMF ID, PDU Session ID, Access Type, RAT type, and PLMN ID

When receiving the above message, the UDM may store the information in a UDR. When there is an associated SUPI for the SUPI1, the UDM may also store the information for a second SUPI (SUPI2).

The UDM may transmit, to the SMF1, a response message including a result indicating a register success.

In step 340, data transmission between the UE, the RAN, and the UPF through 3GPP access may be performed.

In step 351, the UE may transmit a PDU session establishment request message through a registered 3GPP access network by using the SUPI2. The UE may transmit a NAS message including the PDU session establishment request message to the AMF through a second RAN (RAN2). The message may include PDU session ID, S-NSSAI, DNN, and N1 SM container (PDU session establishment request).

When the AMF receives the PDU session establishment request message from the UE, the AMF may determine whether to allow the PDU session establishment based on subscriber information of the UE. When there is no subscriber information, the AMF may transmit a subscriber information request message to the UDM.

The UDM may include PDU session information (S-NSSAI, DNN, PDU session ID, SMF ID, Access Type, PLMN, and/or the like) about an associated SUPI (e.g., an SUPI stored in the same subscription profile) in a response message transmitted to the AMF.

The AMF may determine whether a PDU session having the same S-NSSAI and DNN as the S-NSSAI and DNN included in the PDU session establishment request message received from the UE (or a DS device) in step 351 is present for another 3GPP access (or another SUPI associated with the UE other than the SUPI of the UE) in the message received from the UDM.

When the PDU session is present, in step 352, the AMF may include an indicator indicating to use the PDU session together with the PDU session ID in a message (PDU session accept or reject message) transmitted to the UE.

When the AMF receives the PDU session establishment request message from the UE in step 351, the AMF may transmit an SM context create request message to a second SMF (SMF2). The message may include PDU session ID, S-NSSAI, DNN, and N1 SM container (PDU session establishment request).

When the SMF2 receives the PDU session establishment request message from the AMF, the SMF2 may perform a PDU session establishment procedure.

In step 353, the SMF2 may transmit a subscription information request message to the UDM. The request message may include SUPI2.

The UDM may include PDU session information (S-NSSAI, DNN, PDU session ID, SMF ID, Access Type, PLMN, and/or the like) about an associated SUPI (e.g., an SUPI stored in the same subscription profile) in a response message transmitted to the SMF2.

The SMF2 may determine, in step 353, whether a PDU session having the same S-NSSAI and DNN as the S-NSSAI and DNN included in the message received from AMF in step 351 is present in the message received from the UDM.

When the PDU session is present, the SMF2 may include an indicator indicating to use the PDU session together with the PDU session ID in a message (PDU session accept or reject message) transmitted to the UE through the AMF, in step 361. The SMF may transmit, to the AMF, the above message transmitted to the UE.

In step 362, the SMF2 may transmit a UE configuration information update request message to a PCF to update the configuration information of the UE. The UE configuration information update request message may include a DS policy update request indicator and a UE ID. When the PCF receives a UE configuration information update message, the PCF may transmit the configuration information in steps 250, 261, and 262 of FIG. 2.

For example, step 361 may be performed before or after step 362.

When an SM PCF is present separately from a UE PCF, when the SM PCF receives a UE configuration information update message from the SMF, the SM PCF may transmit a UE configuration information update request message including a UE ID and a DS policy update request indicator to the UE PCF, in step 363.

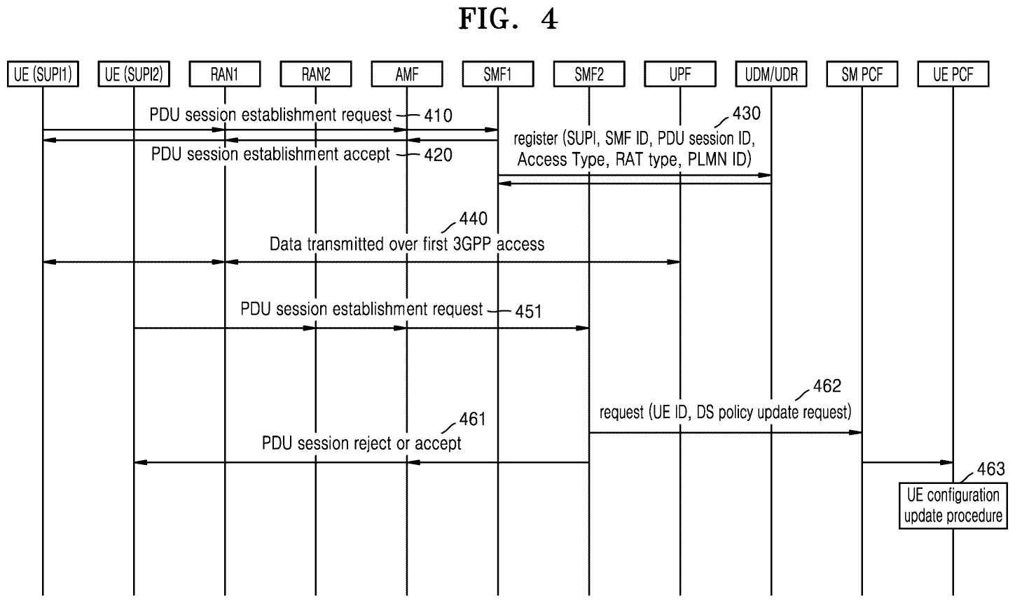

FIG. 4 illustrates a method for session control in a multi-access environment of a wireless communication system according to an embodiment.

Referring to FIG. 4, in step 410, the UE may transmit a PDU session establishment request message through a registered 3GPP access network by using a SUPI1. The UE may transmit a NAS message including the PDU session establishment request message to an AMF through RAN1. The message may include PDU session ID, S-NSSAI, DNN, and N1 session management (SM) container (PDU session establishment request).

When the AMF receives the PDU session establishment request message from the UE, the AMF may transmit an SM context create request message to an SMF1. The SM context create request message may include PDU session ID, S-NSSAI, DNN, and N1 SM container (PDU session establishment request).

When the SMF receives the above message from the AMF, the SMF may perform a PDU session establishment procedure.

In step 420, the SMF may transmit a NAS message including the PDU session establishment accept to the UE through the AMF and the RAN (e.g., the RAN1).

In step 430, the SMF1 may transmit, to a UDM, a message indicating that the SMF1 itself is a serving SMF for the PDU session. The message may include the following information.
SUPI (e.g., SUPI1), SMF ID, PDU Session ID, Access Type, RAT type, and PLMN ID

When receiving the above message, the UDM may store the information in a UDR. When there is an associated SUPI for the SUPI1, the UDM may also store the information for a second SUPI (SUPI2).

The UDM may transmit, to the SMF1, a response message including a result indicating a register success.

In step 440, data transmission between the UE, the RAN, and the UPF through 3GPP access may be performed.

In step 451, the UE may transmit a PDU session establishment request message through a registered 3GPP access network by using the SUPI2. The UE may transmit an NAS message including the PDU session establishment request message to the AMF through a second RAN (RAN2). The message may include PDU session ID, S-NSSAI, DNN, and N1 SM container (PDU session establishment request).

When the AMF receives the PDU session establishment request message from the UE, the AMF may transmit an SM context create request message to a second SMF (SMF2). The message may include PDU session ID, S-NSSAI, DNN, and N1 SM container (PDU session establishment request).

When the SMF2 receives the PDU session establishment request message from the AMF, the SMF2 may perform a PDU session establishment procedure.

The SMF2 may transmit a subscription information request message to the UDM. The request message may include SUPI2.

The UDM may include PDU session information (S-NSSAI, DNN, PDU session ID, SMF ID, Access Type, PLMN, and/or the like) about an associated SUPI (e.g., an SUPI stored in the same subscription profile) in a response message transmitted to the SMF.

The SMF2 may determine whether a PDU session having the same S-NSSAI and DNN as the S-NSSAI and DNN included in the message received from AMF in step 451 is present in the message received from the UDM.

When the PDU session is present, the SMF2 may include an indicator indicating to use the PDU session together with the PDU session ID in a message (PDU session accept or reject message) transmitted to the UE through the AMF, in step 461. The SMF may transmit, to the AMF, the above message transmitted to the UE.

In step 462, the SMF2 may transmit a UE configuration information update request message to a PCF to update the configuration information of the UE. The UE configuration information update request message may include a DS policy update request indicator and a UE ID. When the PCF receives a UE configuration information update message, the PCF may transmit the configuration information through steps 250, 261, and 262 of FIG. 2 described above.

For example, step 461 may be performed before or after step 462.

When an SM PCF is present separately from a UE PCF, when the SM PCF receives a UE configuration information update message from the SMF, the SM PCF may transmit a UE configuration information update request message including a UE ID and a DS policy update request indicator to the UE PCF, in step 463.

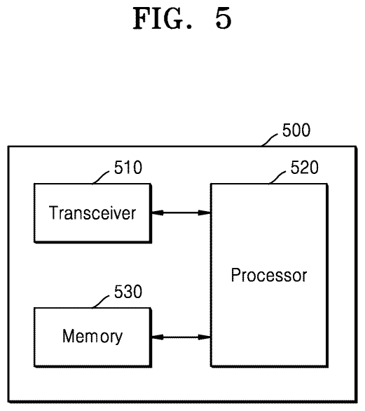

FIG. 5 illustrates a network entity 500 according to an embodiment. Referring to FIG. 5, the network entity 500 may correspond to the NRF, UDR, NSSF, NWDAF, UDM, NSACF, AMF, SMF, PCF, AF, UE, RAN, AN, UPF, or DN illustrated in FIG. 1, FIG. 2, FIG. 3, or FIG. 4.

The network entity 500 may include a transceiver 510, a processor 520, and a memory 530. The transceiver 510, the processor 520, and the memory 530 of the network entity 500 may operate according to the communication method of the network entity 500 described above. However, the components of the network entity 500 are not limited thereto. For example, the network entity 500 may include more components than the above components. In an embodiment of the disclosure, the transceiver 510, the processor 520, and the memory 530 may be implemented as a single chip. The processor 520 may include one or more processors.

The transceiver 510 may collectively refer to a receiver of the network entity 500 and a transmitter of the network entity 500 and may transmit/receive signals to/from a terminal or a base station. The signals transmitted/received to/from the terminal or the base station may include control information and data.

The transceiver 510 may perform functions for transmitting/receiving signals through a wireless channel. For example, the transceiver 510 may receive a signal through a wireless channel and output the signal to the processor 520 and may transmit a signal output from the processor 520, through a wireless channel.

The memory 530 may store programs and data necessary for the operation of the network entity 500. The memory 530 may store control information or data included in the signal obtained by the network entity 500. The memory 530 may include a storage medium or a combination of storage mediums such as a ROM, a RAM, a hard disk, a compact disc (CD)-read only memory (ROM), and a digital versatile disc (DVD). The memory 530 may not be separately provided and may be included in the processor 520. The memory 530 may include a volatile memory, a nonvolatile memory, or a combination of a volatile memory and a nonvolatile memory. The memory 530 may provide the stored data at the request of the processor 520.

The processor 520 may control a series of processes such that the network entity 500 may operate according to the above embodiments of the disclosure. For example, the processor 520 may receive a control signal and a data signal through the transceiver 510 and process the received control signal and data signal. The processor 520 may transmit the processed control signal and data signal through the transceiver 510 and may write/read data into/from the memory 530. The processor 520 may perform functions of a protocol stack required by the communication standard. For this purpose, the processor 520 may include at least one processor or microprocessor. A portion of the transceiver 510 or the processor 520 may be referred to as a communication processor (CP).

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method of an access and mobility function (AMF) in a wireless communication system, the method comprising:
receiving, from a user equipment (UE) supporting a dual steer (DS) function, a PDU session establishment request message through a registered 3GPP access network by using a second SUPI;
determining whether a PDU session having a same S-NSSAI and DNN as an S-NSSAI and DNN included in the PDU session establishment request message is present for another 3GPP access based on subscriber information of the UE; and
in case that the PDU session having the same S-NSSAI and DNN as the S-NSSAI and DNN included in the PDU session establishment request message is present for another 3GPP access, transmitting, to the UE, a PDU session reject message.

2. The method of claim 1, wherein the PDU session establishment request message is received in a non-access stratum (NAS) message through a second RAN.

3. The method of claim 1, wherein the PDU session establishment request message includes at least one of PDU session ID, S-NSSAI, DNN, or N1 session management (SM) container.

4. The method of claim 1, wherein the subscriber information includes PDU session information about a first SUPI which is associated with the second SUPI.

5. The method of claim 4, wherein the first SUPI and the second SUPI is stored in a same subscription profile.

6. The method of claim 1, wherein the PDU session reject message includes an PDU session identifier (ID) of the PDU session having the same S-NSSAI and DNN, and an indicator indicating to use the PDU session.

7. A method of a user equipment (UE) supporting a dual steer (DS) function in a wireless communication system, the method comprising:
transmitting, to an access and mobility function (AMF), a PDU session establishment request message through a registered 3GPP access network by using a second SUPI; and
receiving, from a session management function (SMF), a PDU session establishment response message,
wherein in case that the PDU session having a same S-NSSAI and DNN as an S-NSSAI and DNN included in the PDU session establishment request message is present for another 3GPP access, the PDU session establishment response message includes a PDU session reject message.

8. The method of claim 7, wherein the PDU session establishment request message is transmitted to the AMF in a non-access stratum (NAS) message through a second RAN.

9. The method of claim 7, wherein the PDU session establishment request message includes at least one of PDU session ID, S-NSSAI, DNN, or N1 session management (SM) container.

10. The method of claim 7, wherein the PDU session establishment response message is received through the AMF and a RAN.

11. The method of claim 7, wherein the PDU session reject message includes an PDU session identifier (ID) of the PDU session having the same S-NSSAI and DNN, and an indicator indicating to use the PDU session.

12. An access and mobility function (AMF) in a wireless communication system, comprising:
transceiver; and
at least one processor, configured to:
receive, from a user equipment (UE) supporting a dual steer (DS) function, a PDU session establishment request message through a registered 3GPP access network by using a second SUPI;
determine whether a PDU session having a same S-NSSAI and DNN as an S-NSSAI and DNN included in the PDU session establishment request message is present for another 3GPP access based on subscriber information of the UE; and
in case that the PDU session having the same S-NSSAI and DNN as the S-NSSAI and DNN included in the PDU session establishment request message is present for another 3GPP access, transmit, to the UE, a PDU session reject message.

13. The AMF of claim 12, wherein the PDU session establishment request message includes at least one of PDU session ID, S-NSSAI, DNN, or N1 session management (SM) container.

14. A user equipment (UE) supporting a dual steer (DS) function in a wireless communication system, comprising:
transceiver; and
at least one processor, configured to:
transmit, to an access and mobility function (AMF), a PDU session establishment request message through a registered 3GPP access network by using a second SUPI; and
receive, from a session management function (SMF), a PDU session establishment response message,
wherein in case that the PDU session having a same S-NSSAI and DNN as an S-NSSAI and DNN included in the PDU session establishment request message is present for another 3GPP access, the PDU session establishment response message includes a PDU session reject message.

15. The UE of claim 14, wherein the PDU session establishment request message includes at least one of PDU session ID, S-NSSAI, DNN, or N1 session management (SM) container.
